(19) United States
(12) Patent Application Publication
(10) Pub. No.: US 2024/0265286 A1
(43) Pub. Date: Aug. 8, 2024

(54) FAST CONDITIONAL DISPLACEMENT OF A QUANTUM OSCILLATOR COUPLED TO A QUANTUM BIT

(71) Applicant: Technion Research & Development Foundation Limited, Haifa (IL)

(72) Inventors: Shay HACOHEN-GOURGY, Nofit (IL); Asaf A. DIRINGER, Haifa (IL)

(73) Assignee: Technion Research & Development Foundation Limited, Haifa (IL)

(21) Appl. No.: 18/567,049

(22) PCT Filed: Jun. 7, 2022
(86) PCT No.: PCT/IB2022/055270

§ 371 Date: Dec. 5, 2023

Related U.S. Application Data
(60) Provisional application No. 63/202,340, filed on Jun. 7, 2021.

(51) Int. Cl. G06N 10/20

(52) U.S. Cl. CPC G06N 10/20

(57) ABSTRACT

A method for displacement of an electromagnetic mode (EM) conditioned on the state of an ancilla qubit, the method may include displacing, by applying a displacement operation, an EM mode whose frequencies are conditioned on the state of the ancilla qubit and are spaced apart by a frequency difference, by providing a displacement signal having a bandwidth that exceeds the frequency difference and has a zero amplitude at one or more of the frequencies of the electromagnetic mode which are defined by the displacement operation not to be displaced and a non-zero amplitude at one or more frequencies of the mode which are defined by the displacement operation to be displaced.

### CROSS REFERENCE

This application claims priority from U.S. provisional patent Ser. No. 63/202,340 filing date Jun. 7, 2021, which is incorporated herein by reference.

### BACKGROUND

Circuit-QED realizes a quantum optical laboratory in the microwave regime and a platform for quantum information processing. The effective light-matter interactions are orders of magnitude larger than in natural systems, which make it one of the most versatile quantum technologies to date. The circuits are embedded with Josephson junctions that give rise to non-linearity. This non-linearity makes them behave as artificial atoms at low temperatures in the quantum regime. The circuits are coupled to superconducting resonators and controlled using microwave signals.

Circuit-QED has shown pristine control over all of its constituents, namely, non-linear circuits (qubits), resonators, and microwave photons. Experimental work has made tremendous advances in the last decade, from small-scale quantum simulations, generation and measurement of single photons, demonstrations of entangling gates and simple quantum computing algorithms, creation of non-gaussian photonic cavity states, to the realizations of feedback control, hybrid systems, and dissipation engineering. This technology is widely considered one of the leaders for realizing quantum computers. However, maximizing the potential of circuit-QED for fully stabilizing an encoded quantum state may require conceptual breakthroughs, as no current approach is even close to achieving this task.

The requirements for computation are devices with sufficient coherence times, level of quantum control over its stored information, and potential scalability which are compatible with a workable prototype. On the practical level, any approach must consider where the information is encoded, and importantly which error correction codes are compatible with the approach to allow for scaling. Currently there are two major approaches towards quantum computation in circuit-QED. The approaches differ in where the information is encoded, in the superconducting qubits (non-linear circuits) or in the superconducting resonators.

Superconducting qubits is the most common approach for encoding quantum information. The simplest and most popular circuit is the transmon, which consists of a Josephson junction shunted by a capacitor, and can be understood as an anharmonic oscillator. Qubits based on the two lowest levels of the transmons have been shown to be reliable and highly coherent platforms for encoding information. State-of-the-art circuits consist of tens of transmon qubits with nearest neighbor coupling. Record energy relaxation and coherence times are hundreds of microseconds, and gates and measurement for small systems exceed the error correction threshold. This approach is highly suited for realizing a quantum computer. However, scaling this approach requires hefty resources. This can be witnessed by the fact that such serious scaling attempts are mainly pursued by industry giants like IBM and Google. Moreover, the coherence of the individual components tend to degrade and new error channels such as cross-talks are introduced as the circuits become larger. Current figures show that a single logical qubit would need around a thousand physical qubits for encoding a single logical qubit.

Superconducting resonators (Bosonic codes) provide an alternative platform for encoding information in circuit-QED. Realized with cavities, these show coherence times in the millisecond range. Here, the bosonic modes, when coupled to a transmon, enjoy a large accessible Hilbert space with universal control. The large Hilbert space of the cavity can be used to redundantly encode the information. Furthermore, cavities predominantly suffer from a single loss mechanism, allowing error correction to be efficiently performed on the individual cavity modes with significantly lower hardware overhead as compared with the typical approach. This approach is making impressive progress with advanced stabilization and error correction schemes being demonstrated. This approach is becoming a promising alternative to encoding schemes based on two-level systems due to the relatively lower hardware overhead, modular design, and robust architecture.

A superconductor (SC) qubit such as a transmon that is dispersively coupled to a cavity mode (EM mode), when working in the frame rotating with the ground state of the SC qubit can be described by the circuit-QED dispersive Hamiltonian:

$${H}_{0} = - χ \vert e > < e \vert a a , \qquad ( 1 )$$

with coupling strength χ.

In recent years, various schemes which enable universal control over such systems were developed. Crucial components in implementing and understanding these schemes include SC qubit rotations (EM mode displacements) which are conditioned on number of photons (state of the SC qubit).

Quantum computing may require to perform a displacement of an EM mode whose frequencies are conditioned on the state of the ancilla qubit and are spaced apart by a frequency difference. The displacement operation is typically done by providing a signal having a bandwidth that is very narrow with respect to the frequency difference, and is at the frequency of a target frequency of the frequencies of the EM mode. The narrow bandwidth forces the signal to be time consuming, meaning slow.

As a result, the minimal gate time for implementing the aforementioned universal control by the various schemes scales as ˜/χ.

While it is possible to reduce the gate time by increasing the coupling strength χ, strong couplings must be avoided as higher order terms such as the self-Kerr may not be neglected.

### SUMMARY

There may be provided systems and methods, and computer readable medium as illustrated in the specification.

### BRIEF DESCRIPTION OF THE DRAWINGS

The embodiments of the disclosure will be understood and appreciated more fully from the following detailed description, taken in conjunction with the drawings in which:

FIG. 1 illustrates an example of an anti-symmetrical negatively-conditioning displacement signal;

FIG. 2 illustrates an example of Wigner functions of the EM mode after the application of a of an anti-symmetrical negatively-conditioning displacement signal for different initial states;

FIG. 3 illustrates an example of statistics of photon number expectation values as a function of time during the conditional displacement (CD);

FIG. 4 illustrates an example of a scaling of (a) maximal and (b) average photon number expectation value of EM mode during CD as function of the CD speedup factor;

FIG. 5 illustrates an example of a final state of cavity for initial qubit at ground with/without self-Kerr;

FIG. 6 illustrates an example of displacement fidelity vs speedup factor S_{f} for various χ in the presence of self-Kerr;

FIG. 7 illustrates an example of effects of self-Kerr on quadrature dynamics as a function of the speedup factor S_{f} for various χ;

FIG. 8 illustrates an example of effects of self-Kerr on quadrature dynamics as a function of the speedup factor S/for various χ;

FIG. 9 shows experimental results demonstrating a fast CD by using our anti-symmetrical negatively-conditioning displacement signal;

FIG. 10 illustrates an example of comparing the suggested fast CD to standard Gaussian shaped CD;

FIG. 11 illustrates an example of a method;

FIG. 12 illustrates an example of a method;

FIG. 13 illustrates an example of a method; and

FIG. 14 illustrates an example of a device.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any reference to comprising or having or comprises or comprising should be applied mutatis mutandis to consists or to consisting.

Any reference to comprising or having or comprises or comprising should be applied mutatis mutandis to consists essentially of or to consisting essentially of.

Any combination of any module or unit listed in any of the figures, any part of the specification and/or any claims may be provided.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There is provided a method, a device and a non-transitory computer readable medium for displacement of an electromagnetic mode (EM) conditioned on the state of an ancilla qubit.

There may be provided a method that may displacing, by applying a displacement operation, an EM mode whose frequencies are conditioned on the state of the ancilla qubit and are spaced apart by a frequency difference, by providing a displacement signal having a bandwidth that exceeds the frequency difference and has a zero amplitude at one or more of the frequencies of the electromagnetic mode which are defined by the displacement operation not to be displaced and a non-zero amplitude at one or more frequencies of the mode which are defined by the displacement operation to be displaced.

There may be provided a method that may include displacing a EM mode whose two frequencies are conditioned on the state of a qubit ancilla and are spaced apart by a frequency difference, by providing a displacement signal having a bandwidth that exceeds the frequency difference and has a zero amplitude at an intermediate frequency between the two frequencies of the electromagnetic mode and a non-zero amplitude at the two frequencies.

There may be provided a device for displacement of an electromagnetic mode (EM) conditioned on the state of an ancilla qubit, the device may include a signal generator and the ancilla qubit, wherein the signal generator may be configured to displace, by applying a displacement operation, an EM mode whose frequencies are conditioned on the state of the ancilla qubit and are spaced apart by a frequency difference, by providing a displacement signal having a bandwidth that exceeds the frequency difference and has a zero amplitude at one or more of the frequencies of the electromagnetic mode which are defined by the displacement operation not to be displaced and a non-zero amplitude at one or more frequencies of the mode which are defined by the displacement operation to be displaced.

There may be provided a device for displacement of an electromagnetic mode (EM) conditioned on the state of an ancilla qubit, the device may include a signal generator and the ancilla qubit, wherein the signal generator of configured to displace, by applying a displacement operation, a EM mode whose two frequencies are conditioned on the state of a qubit ancilla and are spaced apart by a frequency difference, by providing a displacement signal having a bandwidth that exceeds the frequency difference and has a zero amplitude at an intermediate frequency between the two frequencies of the electromagnetic mode and a non-zero amplitude at the two frequencies.

There may be provided a non-transitory computer readable medium for displacement of an electromagnetic mode (EM) conditioned on the state of an ancilla qubit, the non-transitory computer readable medium may store instructions for: displacing, by applying a displacement operation, an EM mode whose frequencies are conditioned on the state of the ancilla qubit and are spaced apart by a frequency difference, by providing a displacement signal having a bandwidth that exceeds the frequency difference and has a zero amplitude at one or more of the frequencies of the electromagnetic mode which are defined by the displacement operation not to be displaced and a non-zero amplitude at one or more frequencies of the mode which are defined by the displacement operation to be displaced.

There may be provided a non-transitory computer readable medium for displacement of an electromagnetic mode (EM) conditioned on the state of an ancilla qubit, the non-transitory computer readable medium may store instructions for displacing a EM mode whose two frequencies are conditioned on the state of a qubit ancilla and are spaced apart by a frequency difference, by providing a displacement signal having a bandwidth that exceeds the frequency difference and has a zero amplitude at an intermediate frequency between the two frequencies of the electromagnetic mode and a non-zero amplitude at the two frequencies.

The displacement signal may be a negatively-conditioning displacement signal.

The negatively-conditioning displacement signal may be an anti-symmetrical signal or may differ from an anti-symmetrical signal.

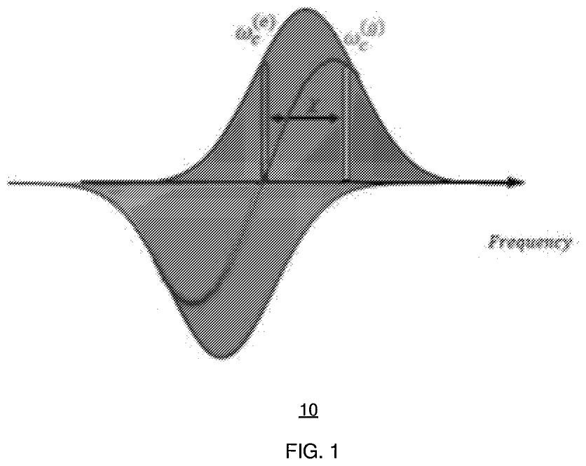

The negatively-conditioning displacement signal may be an anti-symmetrical signal that may include a pair of Gaussian spectrum signals of the same amplitude, opposite phases and having central frequencies that are shifted apart from each other—see, for example, signal 10 of FIG. 1.

The ancilla qubit may be a superconductor ancilla qubit or may differ from a superconductor ancilla qubit.

Any reference to EM mode whose frequencies are conditioned on the state of the ancilla qubit may be applied mutatis mutandis to any other bosonic modes and/or modes that can be described by a quantum harmonic oscillator.

The negatively-conditioning displacement signal may speed up the conditional displacement—even without increasing the coupling strength. Maintaining the coupling strength low may also resolve other potential problems such as smearing of the final coherent and fidelity of the CD remains high even at substantial speedup.

The suggested method may utilize analytically calculated negatively-conditioning displacement signals with non-standard temporal shapes to reduce gate time of the conditional displacement. Such a speedup enables a fast universal control of the bosonic cavity mode while avoiding the undesired effects of the higher order terms.

The negatively-conditioning displacement signal may have different shapes in the frequency domain. For example—the negatively-conditioning displacement signal may be an anti-symmetrical (in the frequency domain) pulse whose Fourier component is zero

Thus—the displacement induced by the negatively-conditioning displacement signal will become selective not on the frequency in question.

The anti-symmetrical signal may implement the conditional displacement (CD) by a pair of pulses with a Gaussian envelope:

$$G ( t , σ , ω , {t}_{0} , A , ϕ ) = \frac{A}{\sqrt{2 {πσ}^{2}}} exp ( - \frac{{( t - {t}_{0} )}^{2}}{2 {σ}^{2}} - i ( ω ( t - {t}_{0} ) + ϕ ) ) ) , \qquad ( 2 )$$

with a relative phase of x, oppositely detuned from the frequency of the EM mode when the SC qubit is Excited

$$( {ω}_{C}^{( e )} = - χ ) -$$

as illustrated in FIG. 1.

a. FIG. 1 is an example of the anti-symmetric CD—Schematic of the two Gaussians, which construct the anti-symmetric CD, in Fourier space. The red and blue Gaussians have the same amplitudes but opposite phases and their center frequencies are equally detuned from either side of the ω_{c}^{(e)} (frequency of the EM mode when the SC qubit is excited). The Fourier transform of the sum of the two Gaussians (qualitatively and partially represented by the black line) is anti-symmetric with respect to ω_{c}^{(e)} and has a node there. The resulting displacement is conditioned on the ground state of the SC qubit.

$${F}^{\vert g 〉} ( 0 \leq t \leq 4 {σ}_{s} ) = G ( t , {σ}_{s} , - χ + ( \frac{1}{{σ}_{s}} + χ ) , 2 {σ}_{s} , {A}_{0} , {ϕ}_{0} ) , + G ( t , {σ}_{s} , - χ - ( \frac{1}{{σ}_{s}} + χ ) , 2 {σ}_{s} , {A}_{0} , {ϕ}_{0} + π ) \qquad ( 3 )$$

where

$${σ}_{S} = \frac{π}{χ \cdot {S}_{f}}$$

such that S_{f} is the speedup factor¹ and we use a total pulse time of 4σₛ, φ₀
and A₀ are arbitrary and respectively determine the direction of the displacement and the final photon number.

The Gaussian shape was chosen as its Fourier transform is easily evaluated while retaining a tight bound on the Fourier restriction on the frequency-time uncertainty. The choice of frequency of the Gaussian waves is meant to maximize the magnitude of the Fourier component of the sum of the two Gaussians at the ground state frequency of the EM mode (ω_{c}^{(g)}).

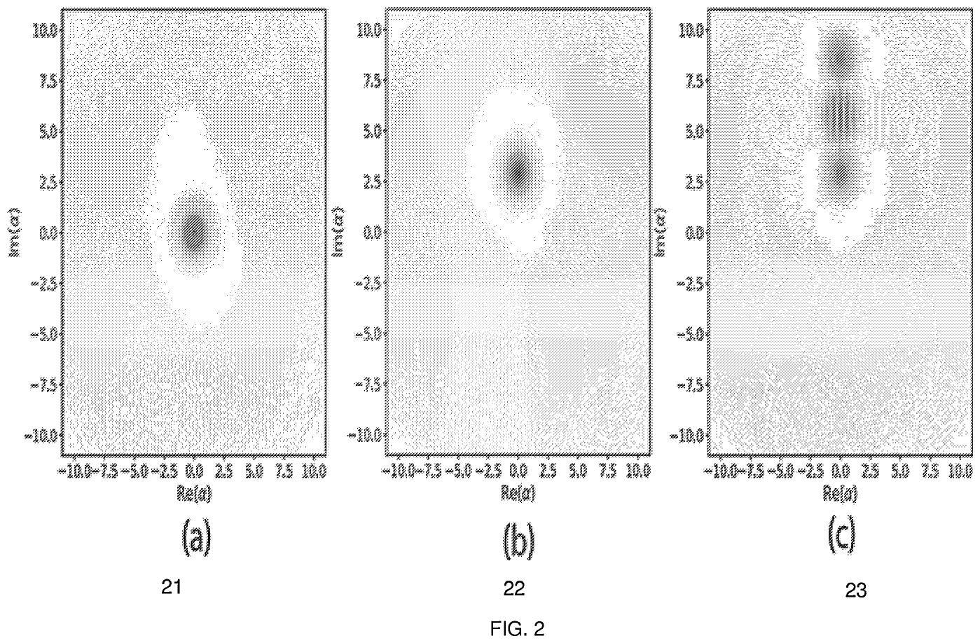

The scheme was validated both in experiment in a circuit-QED system of a transmon qubit coupled to a 3D aluminum cavity, and also simulation with qutip python package. In FIG. 2, we see that the simulation confirms that our drive is indeed conditional; the EM cavity mode is only displaced when the SC qubit is at the ground state. Furthermore, we find that the CD works even for small speedups and does not depend on the initial condition of the EM mode.

FIG. 2 illustrates the Wigner functions of the EM mode after the application of a fast conditional on ground displacement for different initial states. Prior to the pulse, state of the system was (a)|e,0i, (b)|g,0i and (c) (|0>+|i4>). The pulse, defined according to eq. 3 s.t. S_{f}=15 (compared to coupling strength χ/2π=1 MHZ). The amplitude is s.t. the final photon number expectation value is N_{disp}≈4.27 in the direction of the imaginary axis. The x-axis illustrates the real value (ranges between −10 and 10) and the y-axis illustrates the imaginary value (ranges between −10 and 10) in each one of graphs 21, 22 and 23.

In graph 21 ((a)), where the SC qubit is excited, the EM mode remains in the vacuum state. On the other hand in graph 22 ((b)), where the SC is at the ground state, the EM mode is displaced to the final state |i4,27\hat{ }0.5>. Analysis of the EM dynamics shows that during the application of the pulse <Nₘₐₓ≈28. Since the speedup amplitude of the CD were relatively small the maximal displacement of the state during the pulse, of 28, is very of the same order of magnitude as the spread of the initial vacuum state (4). In graph 23 ((c)) demonstrates that our CD is not affected by the constrain of an intermediate displacement much larger than the spread of the Wigner function of the initial state

### Dynamics

### Ideal Case—No Self-Kerr

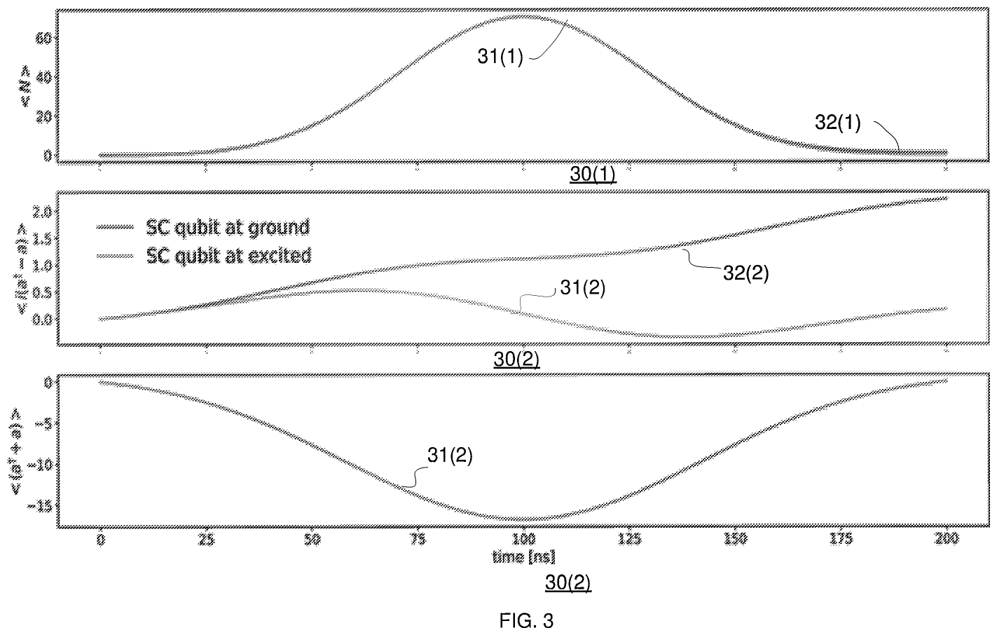

We now turn to characterize the evolution of the system at intermediate times when our pulse is applied. This analysis of the ideal case, where we consider a closed quantum system and neglect higher order terms, provides insight to the drawbacks of the faster CD and the “price” for the speedup expected in a more realistic model. Specifically, in FIG. 3 we find that while the antisymmetric pulse allows for a substantial speedup of the CD, it also leads to large photon number at intermediate times.

We note that undesired effects of higher order terms become more prominent at large photon numbers. Therefore, one may consider Nₘₐₓ, the maximal expectation value of the photon number during the CD, to be the most relevant parameter in evaluating the efficiency of the CD. However, the more relevant parameter for estimating the “price” of the speedup is N_{avg}, the average expectation value of the photon number.

Numerically we find that both parameters scale as:

Nmax/avg∝Ndisp·(Sf)n

where N_{disp} is the characteristic number of photons of the CD, i.e. D^{|gi}(α=^{p}N_{disp}·e^{iφ})=exp([αa^{†}−α*a]|gihg|) and n≈2 for both Nₘₐₓ and N_{avg}.

FIG. 3 illustrates Statistics of photon number expectation values as a function of time during the CD. See TOP graph 30(1) that includes SC qubit at excited curve 31(1) and SC qubit at ground curve 31(2) that almost fully overlap, MIDDLE graph 30(2) that includes SC qubit at excited curve 31(2) and SC qubit at ground curve 31(2) and BOTTOM graph 30(3) that includes SC qubit at excited curve 31(3). The x-axis (time) ranges between 0 and 200 nanoseconds.

Dynamics of the (y-axis of TOP) (hNi), (y-axis of MIDDLE) ha+ai and (y-axis of BOTTOM) i(ha−ai) expectation values of the EM mode during a fast conditional on ground pulse. The pulse, defined according to eq. 3 s.t. S_{f}=50 (compared to coupling strength χ/2π=200 kHz). The amplitude is s.t. the final photon number expectation value is N_{disp}≈1 in the direction of the imaginary axis.

For both SC qubit states, we note that the expectation value at the axis perpendicular to the displacement goes through a ramp up and a ramp down, finally returning to the initial value of (hi(a−a)i=0. Along the displaced axis, the expectation value ha+aichanges monotonically when the SC qubit is at the ground state but oscillates and returns to the zero initial value when the SC qubit is at the excited state.

### Higher Order Terms—Self-Kerr

In the following we analyze the effect of the self-Kerr:

$${ℋ}_{kerr} = \frac{K}{2} {a}^{†} {a}^{†} aa ,$$

on our CD scheme. We evaluate the following undesired effects and discuss how they may be negated.

The self-Kerr, and other terms neglected so far, are most relevant when dealing with states which include many photons. As the state the EM mode at intermediate times of the CD is characterized by a large photon number expectation value, the self-Kerr becomes more prominent. Specifically, the deformation of the coherent state induced by the self-Kerr during the CD becomes substantial.

For simplicity the discussion was provided for an initial state of Vacuum in the EM mode and the SC qubit is at the ground or excited state. For such an ideal system (where there is no self-Kerr), after applying a CD, the system should end up in a coherent (Vacuum) state.

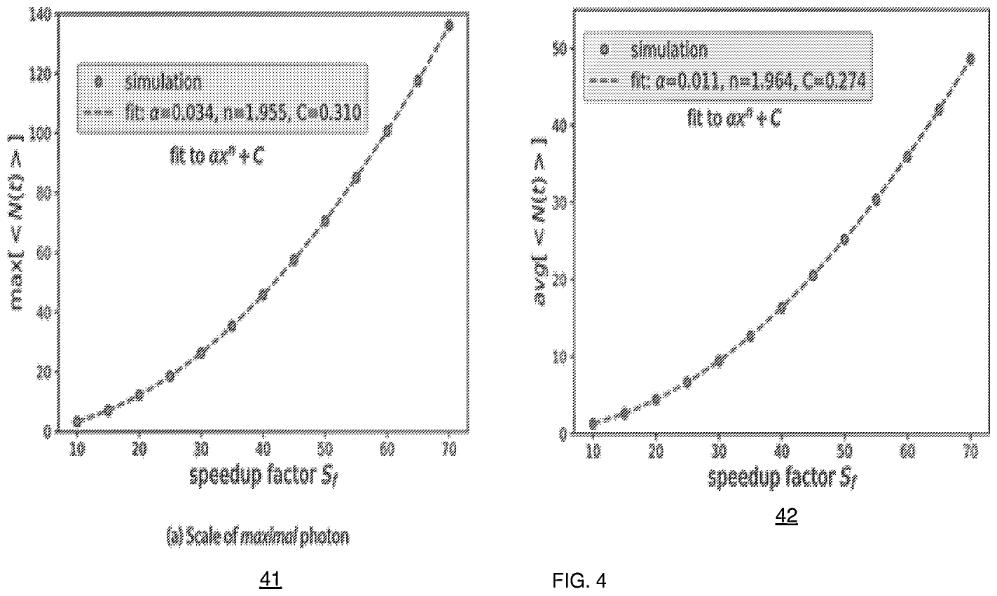

FIG. 4 illustrates a scaling of (a) maximal (graph 41) and (b) average (graph 42) photon number expectation value of EM mode during CD as function of the CD speedup factor S_{f}. The EM mode coupled to the SC qubit with ω/2π=1 MHz and the self-Kerr is neglected. The amplitude of the simulated pulse as (defined by eq. 3) is scaled by S_{f} such that the final photon number expectation value is N_{disp}≈1 (as defined in the text).

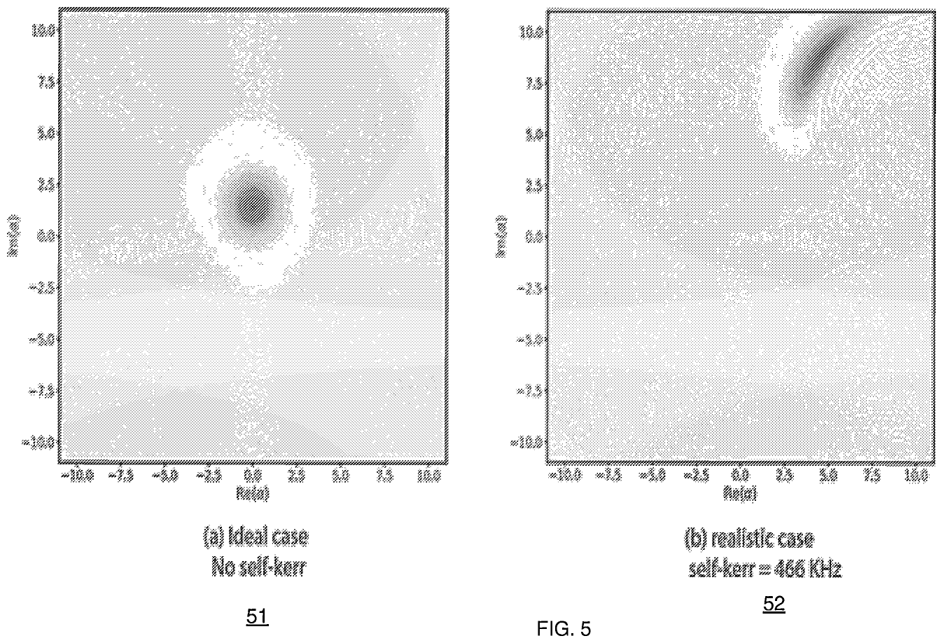

FIG. 5 illustrates a final state of cavity for initial qubit at ground with self-Kerr with K=466.6 kHz (graph 52) or ideal case (graph 51)—no self-Kerr The figures of χ/2π=8 MHz and |α_{f}i≈1 (without self-Kerr) and S_{f}=65. In the presence of the self-Kerr, the final state is deformed and is no longer a coherent state (it has an oval shape rather than the round one expected and found on the right figure). Additional effects of the self-Kerr, when compared to the ideal case (where it is absent), include an increased amplitude and a relative angle of the final state. However, unlike the deformation, such effects are easily negated by proper calibration of the CD on the experimental setup.

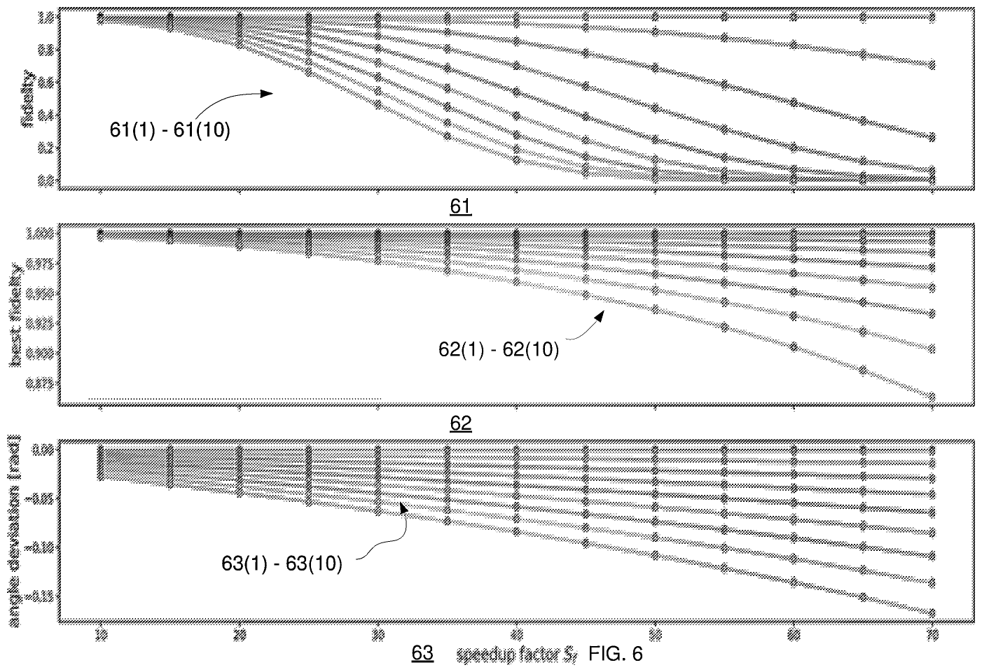

As the self-Kerr deforms coherent states at a rate which is linear in the photon number, the deformation should be proportional to N_{avg}·KT_{CD} (where T_{CD} is the gate time of the CD). Therefore, we expect the smearing of the generated coherent state to increase with the speedup factor S_{f}. As the gate time scales as ˜1/χ while the self-Kerr terms K scales ˜χ², the deformation worsens as χ is increased (FIG. 6).

FIG. 6 illustrates displacement fidelity vs speedup factor S_{f} for various χ in the presence of self-Kerr.

The effects of the self-Kerr on the fidelity of the CD are plotted as a function of the speedup factor S_{f} for different values of the coupling strength x. For an initial state of the system ∥g,0i, we show the fidelity of the final state with the (TOP—graph 61 with curves 61(1)-61(10)) targeted and (MIDDLE—graph 62 with curves 62(1)-62(10)) and closest coherent state and (BOTTOM—graph 63 with curves 63(1)-63(10)) the difference between the angle expectation values if the two (in radians). The targeted (closest) coherent state is defined by the photon number and angle expectation values of the final state simulated on a system where the self-Kerr is neglected (included).

The simulations of the ideal case, where the self-Kerr was neglected, are marked in blue. For each speedup factor the amplitude of each pulse is scaled as A=A₀/S_{f}. A₀ is such that when the self-Kerr is neglected (the ideal case) and the qubit is at ground the final photon number expectation value is Ndisp≈1.

We find that the fidelity to both the targeted and closest coherent states decrease with the speedup as the coupling strength is increased (top and center). The substantial difference between fidelity to the targeted and closest coherent states corresponds to the difference between their respective photon number and angle expectation values. As these self-Kerr induced shifts are easily resolved by an appropriate calibration of the pulse, they should not be considered as major obstacles for the fast CD. The appropriate calibration may be determined, for example, using trial and error—for example by using different signals of different frequencies and selecting the signals that will reduce and even eliminate the self-Kerr induced shifts. Unfortunately, the smearing of the final coherent (see FIG. 5) can not be fixed in such an easy manner. However, we find that at small values of χ the near perfect fidelity persists even at great speedups.

Furthermore, with the self-Kerr the large photon number during the ramp up a effectively changes the frequency of the EM mode. As a result, the pulse is no longer anti-symmetric with respect to ωₑ^{(e)} so the CD is no longer truly conditional. However, for small χ the fidelity of the CD remains high even at substantial speedup.

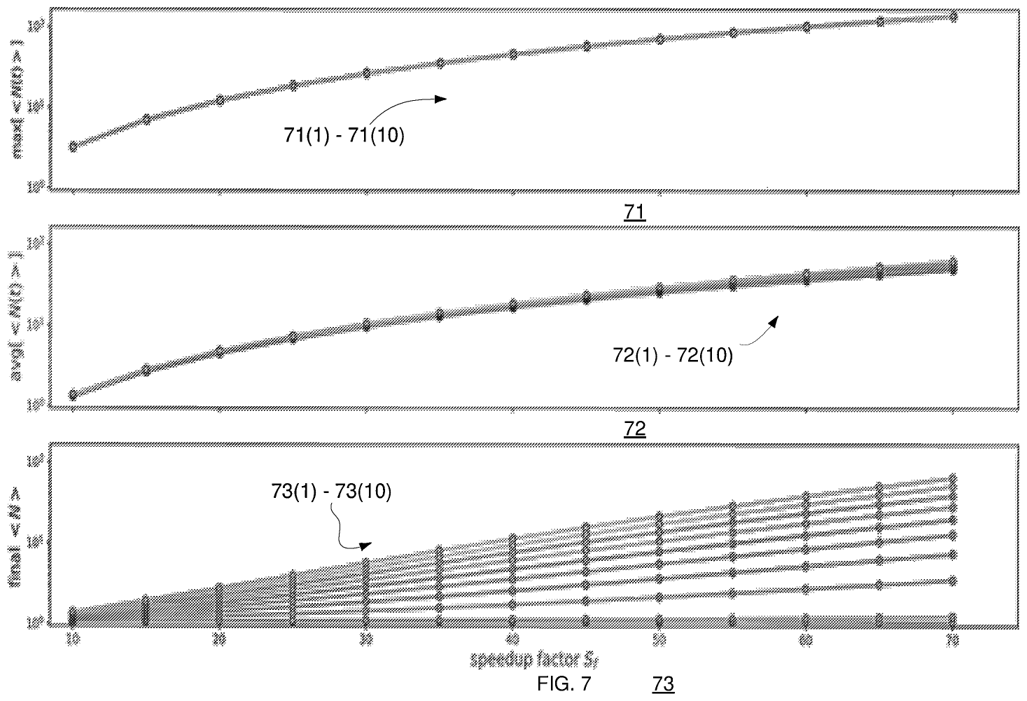

FIG. 7 illustrates Effects of self-Kerr on quadrature dynamics as a function of the speedup factor S_{f} for various χ.

For an initial state |g, 0i, the photon number expectation values during the fast CD are plotted as a function of the speedup factor S_{f} at various values of χ. For each value of χ, the self-Kerr term is taken to be K=χ²/α, where the Transmon anharmonicity was set to α/2π=200 MHz. Simulations of the ideal case, where the self-Kerr was neglected, are marked in blue. For each speedup factor the amplitude of each pulse is scaled as A=A₀/S_{f}. A₀ is such that when the self-Kerr is neglected (the ideal case) and the qubit is at ground the final photon number expectation value is N_{disp}≈1. We find that the maximal photon number (TOP—graph 71 with curves 71(1)-71(10)) expectation value is the same for all values of x. However, at larger x's, the final photon number expectation value (BOTTOM—graph 73 with curves 73(1)-73(10) increases with the speedup. The average values are illustrated in MIDDLE—graph 72 with curves 72(1)-72(10).

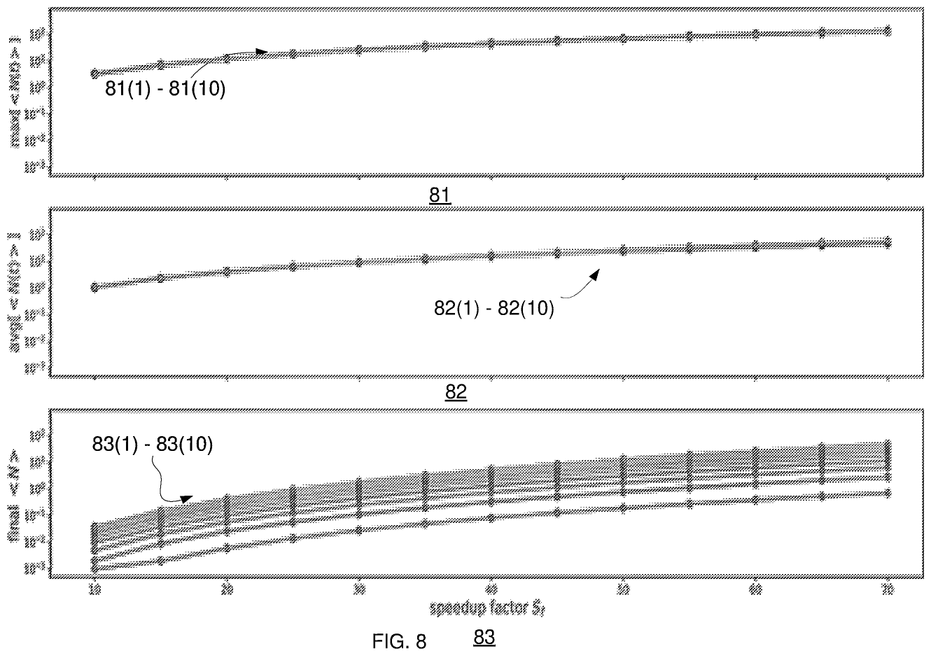

FIG. 8 illustrates Effects of self-Kerr on quadrature dynamics as a function of the speedup factor S_{f} for various χ with the initial state |e,0i.

Maximal values are illustrated in TOP—graph 71 with curves 71(1)-71(10).

Average values are illustrated in MIDDLE—graph 72 with curves 72(1)-72(10).

Final values are illustrated in BOTTOM—graph 73 with curves 73(1)-73(10).

It is worth noting the final photon number expectation number which for a truly CD should be zero. However, we find that at large speedups when the SC qubit is excited this expectation value is non-zero, i.e. the displacement is no longer fully conditional. However, we note that at small enough coupling strengths, the final photon number expectation value is negligible zero, so fast pulse remains practically conditional even at substantial speedups.

The ten curves per each graph of FIGS. 6, 7 and 8 were taken for: χ/2π: 0.1 Mhz with no self-Kerr, χ/2π: 0.1 Mhz, χ/2π: 1 Mhz, χ/2π: 2 Mhz, χ/2π: 3 Mhz, χ/2π: 4 Mhz, χ/2π: 5 Mhz, χ/2π: 6 Mhz, χ/2π: 7 Mhz, and χ/2π: 8 Mhz, respectively.

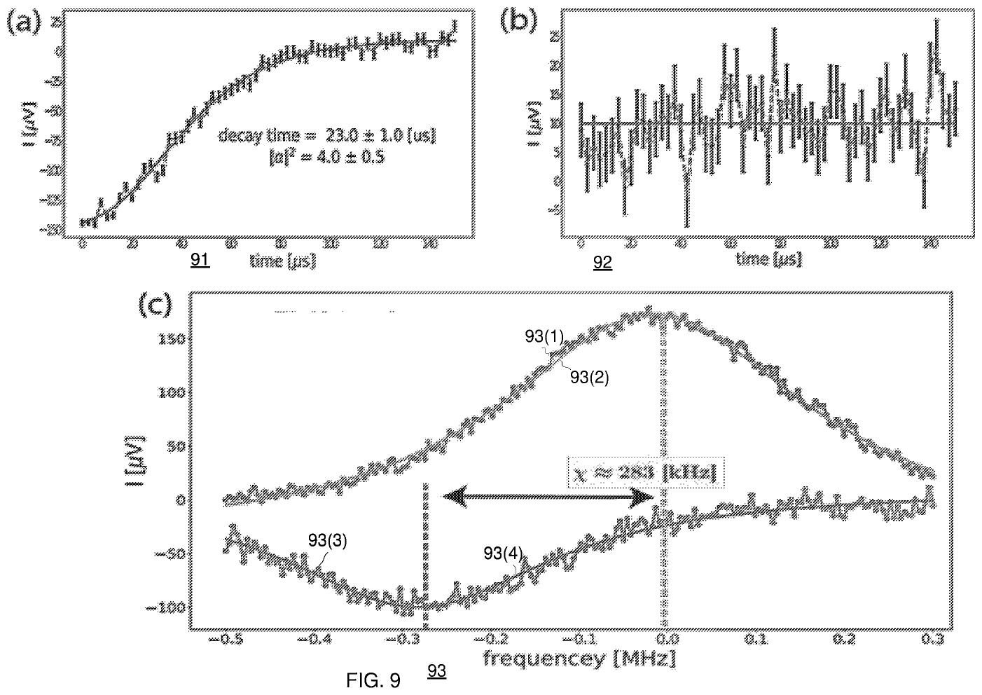

FIG. 9 illustrates experimental results such as graph 91 ((a)) Calibration of a fast conditional on ground displacement. The fast CD is applied so that the cavity should only be displaced when the Transmon is it the ground state. After a waiting time/a slow conditional π rotation of the Transmon maps the occupation of zero photon cavity state on to the excited state of the Transmon. Thus, by repeating this process and measuring the state of the Transmon we get the occupation probability of zero photons.

In FIG. 9, the measured value of the I quadrature, which is proportional to the occupation probability of the Transmon excited state, is plotted as a function the wait time. To obtain the amplitude of the displacement |α| (and the cavity's single photon lifetime T_{c}), the results are fitted to the function I(t)∝e^{-|α|2exp(-t/Tc)}. We get with σ=64 ns, |α|²=4.0. Showing the displacement has occurred. Graph 92 ((b)) is the same as ((a)) only with the addition of unconditional π rotations, one before and one after the fast CD. This means that if the pulse is indeed conditional we should observe a constant value. Graph 93 and curves 93(1)-93(4) are spectroscopic measurement of the cavity mode is plotted as a function of the detuning from it's frequency when the Transmon is in the ground state. The spectroscopy is repeated twice: once when the Transmon starts at the ground state and again after a π rotation, which brings the Transmon to the excited state. Each of the two spectroscopies are fitted to Lorentzians in order to obtain the two cavity frequencies, whose difference is χ.

We implement and test our fast CD experimentally. We use our standard circuit-QED setup and microwave electronics to cooldown a high-Q 3D cavity coupled to a Transmon SC qubit. The system has a χ/2π=283 kHz (see FIG. 2). We test the speed up limits of our fast CD through a comparison to the standard scheme for a CD which involves a single narrow-band Gaussian (see FIG. 2). We find that our scheme allows a speedup of the conditional by a factor of approximately 60 for this system. The speed up is limited only technically by the power available to us in the system. More amplification would have resulted in a larger speed up. Specifically, we are attempting to introduce a great amount of power to the EM mode in a short amount of time. Our scheme produces a substantial speedup without any optimization or even modification of our electronics and setup (i.e. so we far we have used our standard, equipment available in lab). Future analysis will attempt to increase the speedup and explore the limits. This will be done by modification of the electronics and setup; first by reconsidering the thermal budget and reducing attenuation, next by applying better suited “off the shelf” amplification and perhaps by considering more exotic electronics.

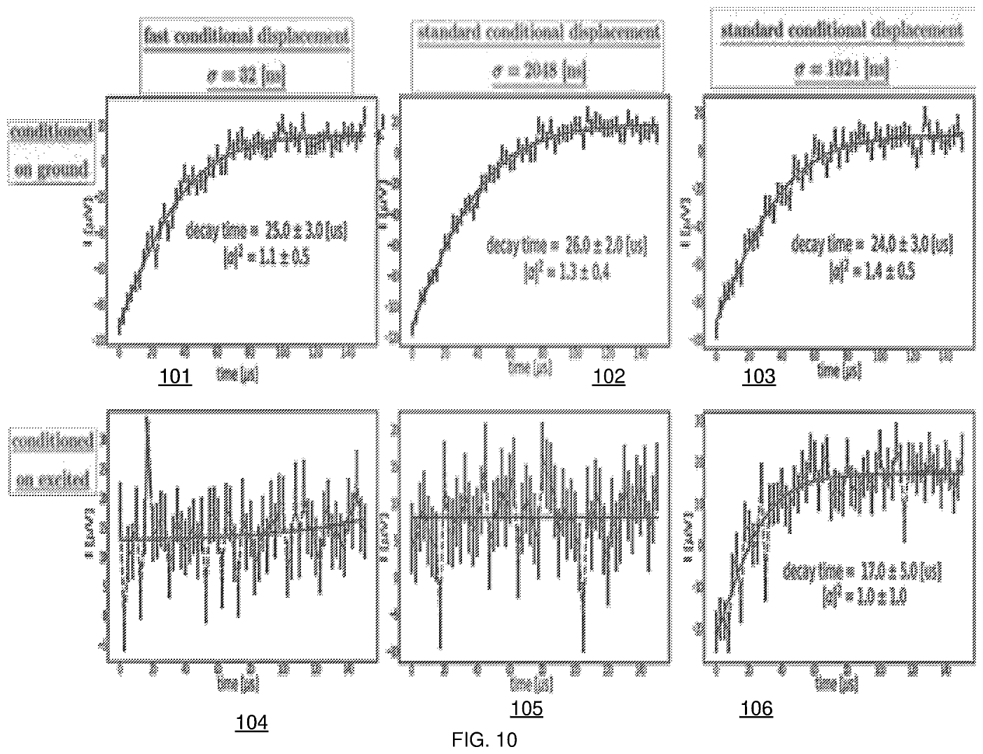

FIG. 10 illustrates a comparing of the fast CD to standard Gaussian shaped CD.

Graphs 101, 102 and 103 were taken while the qubit was conditioned on ground. Graphs 104, 105 and 106 were taken while the qubit was conditioned on excited. Graphs 101 and 104 were taken with fast conditional displacement with σ=32 nanoseconds. Graphs 102 and 105 were taken with standard conditional displacement with σ=2048 nanoseconds. Graphs 103 and 106 were taken with standard conditional displacement with σ=1024 nanoseconds.

We preform the same calibration procedure described in 2 (a) on various pulses. The fast pulses (LEFT) are defined according to eq. 3 with σ=32 ns and a drive amplitude of 0.45 [V] The standard Gaussian pulse is defined according to eq. 2 with σ=2048 ns (σ=1024 ns) and a drive amplitude of 0.0006 [V] (0.0012 [V]). All pulses include a ramp up and ramp down time of 40 resulting in an overall pulse time of 80 respectively. For the top row, the frequency of the pulses is such that the displacements should be conditional on the ground state. However, at the bottom row the frequency of the pulses are shifted by −283 kHz, making them conditional on the excited state of the Transmon. For the displacements that should be conditioned on the ground state of the Transmon, we find clear dynamics of the signal well above the noise level.

At the bottom row, when the displacements should be conditioned on the excited state of the Transmon, the pulse should leave the cavity in the vacuum state. Therefore, we expect to find for such pulses a flat line similar to FIG. 2 (b) indicating no displacement. Indeed, we obtain such a result for the fast CD and the standard CD with σ=2048 ns. However, for the standard CD with σ=2048 ns we find that cavity mode is clearly displaced.

In order to improve the fidelity of the conditional displacement obtained by the antisymmetric pulse, a pi rotation on the qubit ancilla followed by an additional antisymmetric pulse with a negative amplitude. These additions help negate unwanted effects caused by high order terms such as cross Kerr. Furthermore, by applying at the same time of the pi rotation a (digital) frame rotation on the EM mode, at an angle proportional to the duration of the anti-symmetric pulse, one can correct the unwanted evolution induced by the undriven hamiltonian.

One or more properties of the pulse (for example spectrum) may be determined based on various parameters such as the scaling of intermediate photon numbers with S_{f}.

Anti-symmetric pulses other than the pulse of FIG. 1 may be used as a CD. Properties of other pulses may be determined in various manners—for example—based on an analysis of the pulse and the SC qubit.

Adding drives which are constrained to the anti-symmetric Fourier shape as explicit unconditional displacements, may provide a more efficient control scheme

It may also help working in a more natural basis of the Harmonic oscillator to “help” the optimal control algorithms converge.

The conditional displacement illustrated above (using a negative-conditioning signal) may be applied mutatis mutandis to a low-Q mode for a faster readout.

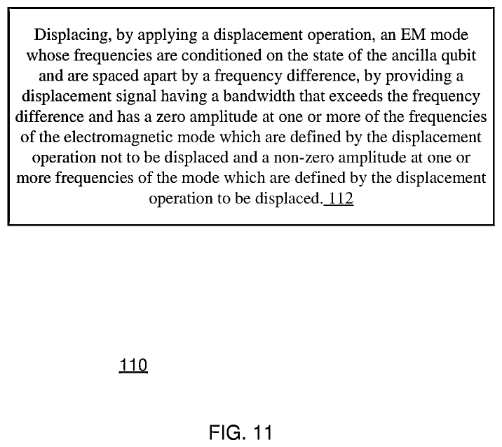

FIG. 11 illustrates an example of method 110 for displacement of an electromagnetic mode (EM) conditioned on the state of an ancilla qubit.

Method 110 may include step 112 of displacing, by applying a displacement operation, an EM mode whose frequencies are conditioned on the state of the ancilla qubit and are spaced apart by a frequency difference, by providing a displacement signal having a bandwidth that exceeds the frequency difference and has a zero amplitude at one or more of the frequencies of the electromagnetic mode which are defined by the displacement operation not to be displaced and a non-zero amplitude at one or more frequencies of the mode which are defined by the displacement operation to be displaced.

The displacement signal may be a negatively-conditioning displacement signal.

The negatively-conditioning displacement signal may be an anti-symmetrical signal.

The negatively-conditioning displacement signal may differ from an anti-symmetrical signal.

The negatively-conditioning displacement signal may be an anti-symmetrical signal that includes a pair of Gaussian spectrum signals of the same amplitude, opposite phases and having central frequencies that are shifted apart from each other. An example of such a signal is provided in FIG. 1.

The ancilla qubit may be a superconductor ancilla qubit.

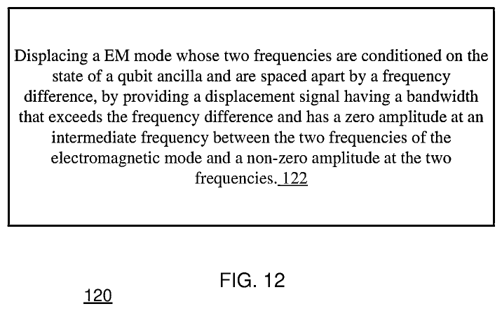

FIG. 12 is an example of method 120 for displacement of an electromagnetic mode (EM) conditioned on the state of an ancilla qubit.

Method 120 may include step 122 of displacing a EM mode whose two frequencies are conditioned on the state of a qubit ancilla and are spaced apart by a frequency difference, by providing a displacement signal having a bandwidth that exceeds the frequency difference and has a zero amplitude at an intermediate frequency between the two frequencies of the electromagnetic mode and a non-zero amplitude at the two frequencies.

The displacement signal may be a negatively-conditioning displacement signal.

The negatively-conditioning displacement signal may be an anti-symmetrical signal.

The negatively-conditioning displacement signal may differ from an anti-symmetrical signal.

The negatively-conditioning displacement signal in an anti-symmetrical signal that comprises a pair of Gaussian spectrum signals of the same amplitude, opposite phases and having central frequencies that are shifted apart from each other.

The ancilla qubit may be a superconductor ancilla qubit.

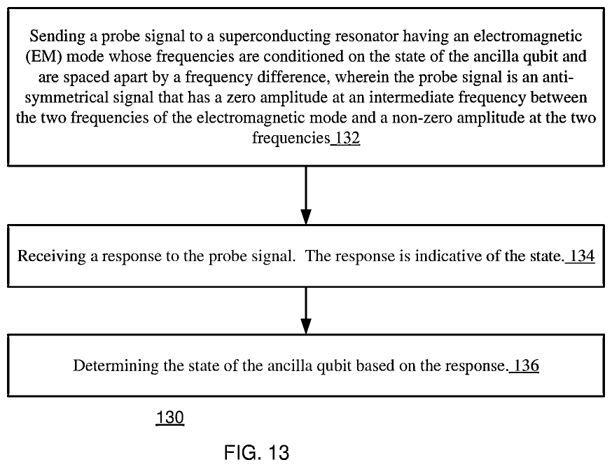

FIG. 13 is an example of method 130 for reading a state of an ancilla qubit.

Method 130 may include step 132 of sending a probe signal to a superconducting resonator having an electromagnetic (EM) mode whose frequencies are conditioned on the state of the ancilla qubit and are spaced apart by a frequency difference, wherein the probe signal is an anti-symmetrical signal that has a zero amplitude at an intermediate frequency between the two frequencies of the electromagnetic mode and a non-zero amplitude at the two frequencies.

Step 132 may be followed by step 134 of receiving a response to the probe signal. The response is indicative of the state.

Step 134 may be followed by step 136 of determining the state of the ancilla qubit based on the response.

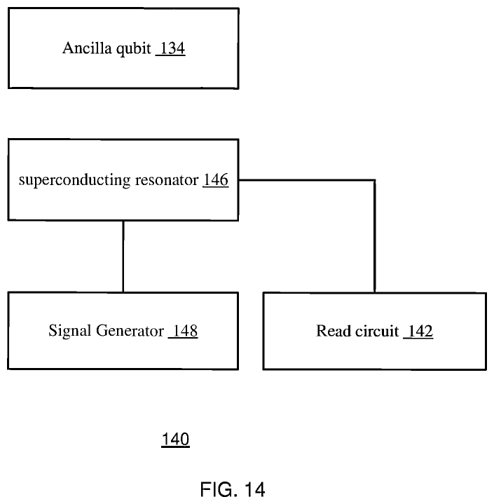

FIG. 14 illustrated an example of a device 140 that includes a read circuit 142, an ancilla qubit 144, a superconducting resonator 146, and a signal generator 148.

Device 140 may execute one, some or all of methods 110, 120 or 130.

The superconducting resonator 146 is being probed to determine the state of the ancilla qubit. The superconducting resonator 146 has an electromagnetic (EM) mode whose frequencies are conditioned on the state of the ancilla qubit.

The signal generator 148 is configured to displace, by applying a displacement operation, an EM mode whose frequencies are conditioned on the state of the ancilla qubit and are spaced apart by a frequency difference, by providing a displacement signal having a bandwidth that exceeds the frequency difference and has a zero amplitude at one or more of the frequencies of the electromagnetic mode which are defined by the displacement operation not to be displaced and a non-zero amplitude at one or more frequencies of the mode which are defined by the displacement operation to be displaced.

Additionally or alternatively, the signal generator 148 is configured to displace a EM mode whose two frequencies are conditioned on the state of a qubit ancilla and are spaced apart by a frequency difference, by providing a displacement signal having a bandwidth that exceeds the frequency difference and has a zero amplitude at an intermediate frequency between the two frequencies of the electromagnetic mode and a non-zero amplitude at the two frequencies.

The read circuit 142 is configured to (a) send a probe signal to a superconducting resonator having an electromagnetic (EM) mode whose frequencies are conditioned on the state of the ancilla qubit and are spaced apart by a frequency difference, wherein the probe signal is an anti-symmetrical signal that has a zero amplitude at an intermediate frequency between the two frequencies of the electromagnetic mode and a non-zero amplitude at the two frequencies, and (b) receive a response to the probe signal.

Device 140 may be configured to determine the state of the ancilla qubit—for example by the read circuit or by a determination unit (not shown) that does not belong to the read circuit. Alternatively—the state is determined outside the device 140.

In relation to any method and/or device and/or non-transitory computer readable medium—the activation signal may be a negatively-conditioning displacement signal, may be a negatively-conditioning displacement signal that is anti-symmetrical, may be a negatively-conditioning displacement signal that is differs from an anti-symmetrical signal, or may be an anti-symmetrical signal that comprises a pair of Gaussian spectrum signals of the same amplitude, opposite phases and having central frequencies that are shifted apart from each other.

In relation to any method and/or device and/or non-transitory computer readable medium—the ancilla qubit may be a superconductor ancilla qubit.

Any reference to “may be” may be applied mutatis mutandis to may not be.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A method for displacement of an electromagnetic mode (EM) conditioned on the state of an ancilla qubit, the method comprising:
displacing, by applying a displacement operation, an EM mode whose frequencies are conditioned on the state of the ancilla qubit and are spaced apart by a frequency difference, by providing a displacement signal having a bandwidth that exceeds the frequency difference and has a zero amplitude at one or more of the frequencies of the electromagnetic mode which are defined by the displacement operation not be displaced and a non-zero amplitude at one or more frequencies of the mode which are defined by the displacement operation to be displaced.

2. The method according to claim 1 wherein the displacement signal is a negatively-conditioning displacement signal.

3. The method according to claim 2 wherein the negatively-conditioning displacement signal is an anti-symmetrical signal.

4. The method according to claim 2 wherein the negatively-conditioning displacement signal differs from an anti-symmetrical signal.

5. The method according to claim 2 wherein the negatively-conditioning displacement signal in an anti-symmetrical signal that comprises a pair of Gaussian spectrum signals of the same amplitude, opposite phases and having central frequencies that are shifted apart from each other.

6. The method according to claim 1 wherein the ancilla qubit is a superconductor ancilla qubit.

7. A device for displacement of an electromagnetic mode (EM) conditioned on the state of an ancilla qubit, the device comprises a signal generator and the ancilla qubit, wherein the signal generator is configured to displace, by applying a displacement operation, an EM mode whose frequencies are conditioned on the state of the ancilla qubit and are spaced apart by a frequency difference, by providing a displacement signal having a bandwidth that exceeds the frequency difference and has a zero amplitude at one or more of the frequencies of the electromagnetic mode which are defined by the displacement operation not to be displaced and a non-zero amplitude at one or more frequencies of the mode which are defined by the displacement operation to be displaced.

8. The device according to claim 7 wherein the displacement signal is a negatively-conditioning displacement signal.

9. The device according to claim 8 wherein the negatively-conditioning displacement signal is an anti-symmetrical signal.

10. The device according to claim 8 wherein the negatively-conditioning displacement signal differs from an anti-symmetrical signal.

11. The device according to claim 8 wherein the negatively-conditioning displacement signal in an anti-symmetrical signal that comprises a pair of Gaussian spectrum signals of the same amplitude, opposite phases and having central frequencies that are shifted apart from each other.

12. The device according to claim 7 wherein the ancilla qubit is a superconductor ancilla qubit.

13. A non-transitory computer readable medium for displacement of an electromagnetic mode (EM) conditioned on the state of an ancilla qubit, the non-transitory computer readable medium stores instructions for: displacing, by applying a displacement operation, an EM mode whose frequencies are conditioned on the state of the ancilla qubit and are spaced apart by a frequency difference, by providing a displacement signal having a bandwidth that exceeds the frequency difference and has a zero amplitude at one or more of the frequencies of the electromagnetic mode which are defined by the displacement operation not to be displaced and a non-zero amplitude at one or more frequencies of the mode which are defined by the displacement operation to be displaced.

14. The non-transitory computer readable medium according to claim 14 wherein the displacement signal is a negatively-conditioning displacement signal.

15. The non-transitory computer readable medium according to claim 15 wherein the negatively-conditioning displacement signal is an anti-symmetrical signal.

16. The non-transitory computer readable medium according to claim 15 wherein the negatively-conditioning displacement signal differs from an anti-symmetrical signal.

17. The non-transitory computer readable medium according to claim 15 wherein the negatively-conditioning displacement signal in an anti-symmetrical signal that comprises a pair of Gaussian spectrum signals of the same amplitude, opposite phases and having central frequencies that are shifted apart from each other.

18. The non-transitory computer readable medium according to claim 14 wherein the ancilla qubit is a superconductor ancilla qubit.

19. A method for displacement of an electromagnetic mode (EM) conditioned on the state of an ancilla qubit, the method comprising: displacing a EM mode whose two frequencies are conditioned on the state of a qubit ancilla and are spaced apart by a frequency difference, by providing a displacement signal having a bandwidth that exceeds the frequency difference and has a zero amplitude at an intermediate frequency between the two frequencies of the electromagnetic mode and a non-zero amplitude at the two frequencies.

20. The method according to claim 19 wherein the displacement signal is a negatively-conditioning displacement signal.

21. The method according to claim 20 wherein the negatively-conditioning displacement signal is an anti-symmetrical signal.

22. The method according to claim 20 wherein the negatively-conditioning displacement signal differs from an anti-symmetrical signal.

23. The method according to claim 20 wherein the negatively-conditioning displacement signal in an anti-symmetrical signal that comprises a pair of Gaussian spectrum signals of the same amplitude, opposite phases and having central frequencies that are shifted apart from each other.

24. The method according to claim 19 wherein the ancilla qubit is a superconductor ancilla qubit.

25. A device for displacement of an electromagnetic mode (EM) conditioned on the state of an ancilla qubit, the device comprises a signal generator and the ancilla qubit, wherein the signal generator is configured to displace, by applying a displacement operation, a EM mode whose two frequencies are conditioned on the state of a qubit ancilla and are spaced apart by a frequency difference, by providing a displacement signal having a bandwidth that exceeds the frequency difference and has a zero amplitude at an intermediate frequency between the two frequencies of the electromagnetic mode and a non-zero amplitude at the two frequencies.

26. The device according to claim 25 wherein the displacement signal is a negatively-conditioning displacement signal.

27. The device according to claim 26 wherein the negatively-conditioning displacement signal is an anti-symmetrical signal.

28. The device according to claim 26 wherein the negatively-conditioning displacement signal differs from an anti-symmetrical signal.

29. The device according to claim 26 wherein the negatively-conditioning displacement signal in an anti-symmetrical signal that comprises a pair of Gaussian spectrum signals of the same amplitude, opposite phases and having central frequencies that are shifted apart from each other.

30. The device according to claim 25 wherein the ancilla qubit is a superconductor ancilla qubit.

31. A non-transitory computer readable medium for displacement of an electromagnetic mode (EM) conditioned on the state of an ancilla qubit, the non-transitory computer readable medium stores instructions for displacing a EM mode whose two frequencies are conditioned on the state of a qubit ancilla and are spaced apart by a frequency difference, by providing a displacement signal having a bandwidth that exceeds the frequency difference and has a zero amplitude at an intermediate frequency between the two frequencies of the electromagnetic mode and a non-zero amplitude at the two frequencies.

32. A method for reading a state of an ancilla qubit, the method comprising: sending a probe signal to a superconducting resonator having an electromagnetic (EM) mode whose frequencies are conditioned on the state of the ancilla qubit and are spaced apart by a frequency difference, wherein the probe signal is an anti-symmetrical signal that has a zero amplitude at an intermediate frequency between the two frequencies of the electromagnetic mode and a non-zero amplitude at the two frequencies; and receive a response to the probe signal.

33. A non-transitory computer readable medium for reading a state of an ancilla qubit, the non-transitory computer readable medium stores instructions for: sending a probe signal to a superconducting resonator having an electromagnetic (EM) mode whose frequencies are conditioned on the state of the ancilla qubit and are spaced apart by a frequency difference, wherein the probe signal is an anti-symmetrical signal that has a zero amplitude at an intermediate frequency between the two frequencies of the electromagnetic mode and a non-zero amplitude at the two frequencies; and receive a response to the probe signal.

34. A device for reading a state of an ancilla qubit, the device comprises a read circuit, wherein the read circuit is configured to (a) send a probe signal to a superconducting resonator having an electromagnetic (EM) mode whose frequencies are conditioned on the state of the ancilla qubit and are spaced apart by a frequency difference, wherein the probe signal is an anti-symmetrical signal that has a zero amplitude at an intermediate frequency between the two frequencies of the electromagnetic mode and a non-zero amplitude at the two frequencies, and (b) receive a response to the probe signal.
